(19) United States
(12) Patent Application Publication
(10) Pub. No.: US 2023/0337704 A1
(43) Pub. Date: Oct. 26, 2023

(54) OPTIMIZED PROCESS FOR DEEP FREEZING AND DEFROSTING OF FOODSTUFFS AND OTHER HEAT-SENSITIVE PRODUCTS IN A DEEP FREEZING CABINET

(71) Applicant: L'Air Liquide, Societe Anonyme pour l'Etude et l’Exploitation des Procedes Georges Claude, Paris (FR)

(72) Inventor: Didier PATHIER, Shanghai (CN)

(73) Assignee: L'Air Liquide, Societe Anonyme pour l'Etude et l’Exploitation des Procedes Georges Claude, Paris (FR)

(21) Appl. No.: 18/138,712

(22) Filed: Apr. 24, 2023

(30) Foreign Application Priority Data
Apr. 25, 2022 (FR) FR 2203791

(51) Int. Cl. A23L 3/365; A23L 3/36

(52) U.S. Cl. CPC A23L 3/365; A23L 3/363

(57) ABSTRACT

Processes for deep freezing and defrosting of products, in particular foodstuff products, wherein a constant speed of deep freezing is maintained throughout the process, and in that, in order to defrost the products, the products are subjected to a constant defrosting speed throughout the defrosting process.

### CROSS-REFERENCE TO RELATED APPLICATIONS

This application claims the benefit of priority under 35 U.S.C. § 119 (a) and (b) to FR patent application No. FR 2203791, filed Apr. 25, 2022, the entire contents of which are incorporated herein by reference.

### FIELD OF THE INVENTION

The present invention relates to the field of processes for deep freezing of foodstuffs, pharmaceutical or also biological products.

### BACKGROUND

It is known that processes for deep freezing, then defrosting of products, have a considerable impact on the quality of the products obtained.

Thus, a process which provides excessively slow freezing will generate large ice crystals, giving rise to substantial losses of water during the defrosting, and consequently to low quality of the products.

On the other hand, excessively rapid freezing gives rise to high energy consumption, and can likewise generate quality problems, such as, for example, destruction of blood cells during excessively rapid deep freezing of blood, or bursting of certain sensitive products such as strawberries when they are frozen too rapidly.

### SUMMARY

The present invention involves processes for deep freezing implemented in enclosures of the “cabinet” or “enclosure” type (processes which are said to be in “lot” or “batch” mode, unlike processes with continuous travel in a tunnel). Reference can be made for example to the “Cryo-Cabinet” cryogenic deep freezing cabinets sold by the applicant, or also the cabinets sold by the company ACFRI.

This equipment is conventionally constituted by an insulating enclosure provided with an access door making it possible to deposit the hot products in the interior, and extract them after they have been deep frozen. In operation, the door is closed and the enclosure is closed. A source of cold provides the cold necessary to obtain the set temperature. This source of cold can be an injection of cryogenic fluid or a heat exchanger of a mechanical cooling unit. Internal ventilation makes it possible to circulate the cold thus provided and to facilitate the thermal transfers with the product to be deep frozen. All of the parameters (temperature, ventilation power) are adjustable according to the process, and the duration of deep freezing is also adjustable.

### BRIEF DESCRIPTION OF THE FIGURES

The present invention and its advantages are illustrated in the following non-limiting examples, reference being made to FIG. 1 to FIG. 8, wherein:

FIG. 1 is different temperature curves of a product, on a time basis, with a curve for each depth in the interior of the product;

FIG. 2 is different temperature curves of a product, on a time basis, with a curve for each depth in the interior of the product showing variable gradients;

FIG. 3 is the results of simulation of a deep freezing process according to the invention in a deep freezing cabinet of this type, implementing a constant speed of deep freezing;

FIG. 4 is the results of simulation of a deep freezing process according to the invention in a deep freezing cabinet of this type, implementing a constant speed of deep freezing showing a constant gradient;

FIG. 5 is the results of simulation of a defrosting process according to the prior art (“standard”) in equipment of the cabinet type;

FIG. 6 is the results of simulation of a defrosting process according to the prior art (“standard”) in equipment of the cabinet type showing variable gradients;

FIG. 7 is the results of simulation of a defrosting process according to the invention in a cabinet of this type, implementing a constant defrosting speed; and

FIG. 8 show the results of simulation of a defrosting process according to the invention in a cabinet of this type, implementing a constant defrosting speed, showing a constant gradient.

### DETAILED DESCRIPTION OF THE INVENTION

When a product has been frozen in cabinets of this type by means of a traditional process, i.e. at a freezing temperature which is constant over a period of time, using a coefficient of thermal transfer which is constant over a period of time, the surface of the product is frozen far faster than the core of the product. As a consequence, this gives rise to the fact that the quality and characteristics of the product is/are not identical within the volume of the product, which constitutes a real problem for certain, medical or biological products, or for certain proteins, or also for certain delicate fruits.

It will be appreciated that solutions have been proposed for this problem in this technical field, such as, for example, high-speed freezing technologies of the vitrification type, which vitrification gives very good results, but is substantially suitable for very small products.

The objective of the present invention is to propose a technical solution for the problem described above.

For this purpose, it is proposed here to maintain a constant deep freezing speed during the entire process, in other words, the deep freezing front is displaced towards the centre of the product at a given and constant speed.

This also means that each portion of the product will be frozen in a given and fixed time.

The surface of the product is thus not frozen more rapidly than the core of the product.

In order to achieve this, one of the following embodiments is implemented:
According to a first embodiment, the temperature which exists in the installation is not constant, it is relatively high (i.e. not too cold) at the start of the process, and colder at the end of the process in order to stimulate the deep freezing which slows down.
   According to a second embodiment, the temperature which exists in the enclosure has a given and fixed set point, whereas the coefficient of thermal transfer is regulated so as to be low at the start of the process, and higher at the end of the process (for this purpose, the ventilation speed is slow at the start of the deep freezing cycle, and higher at the end of the deep freezing).
   According to a third mode, the two preceding modes are associated (variation of the temperature and variation of the coefficient of thermal transfer).

The following evaluation formulation may be considered for example:

Temperature of the process=k×time which has elapsed since the start of the deep freezing process(time expressed in seconds)+A

In the case when A=+5° C., a deep freezing temperature is obtained which starts at +5° C., and will drop progressively and linearly to −20 or −40 or −60° C. according to the time which will have elapsed.

For a deep freezing process, the coefficient k is negative, and a low value of k (i.e. a high absolute and negative value) gives rise to a rapid deep freezing speed. For example, if k=−1/60, there will be a speed of descent into cold equal to 1° C. per minute. If on the other hand k=−10/60, there will be a far more rapid descent into cold, equal to 10° C. per minute.

The same type of evaluation can be put into effect for the defrosting process, with a coefficient k which is positive:

Temperature of the product=k×time which has elapsed since the start of the defrosting process+A.

Below the results are given of simulations carried out in the conditions of the invention, or in comparative conditions (prior art).

The following general comment can be made about these simulations: the curves below have been obtained by simulation, but the experiments have shown that these simulations approximate the reality very efficiently.

Furthermore, in addition to “real” experiments, it should be emphasised that it is also useful to carry out calculations by simulation in order to understand the physical phenomena well. In fact, whereas an experiment provides only a macroscopic result (product which is well deep frozen or not, appearance, etc.), a simulation makes it possible to understand what has very probably happened during the deep freezing. This makes it possible to understand precisely what happens in all the layers of the product (temperature curve millimetre by millimetre in the thickness of the product), and no longer to have only a mean temperature.

Practical tests have thus been carried out in conditions close to those used for the simulations described below, and the same tendency has been found and confirmed (for example a constant speed of deep freezing when the technique described is applied).

In this case, the product was not deep frozen at the outset. The product used (a tylose gel in one experiment and red meat in another experiment) had the property of changing colour when it was deep frozen. A section of product was then deep frozen on only one of its faces, and the advance of the deep freezing front could then be determined on the other faces.

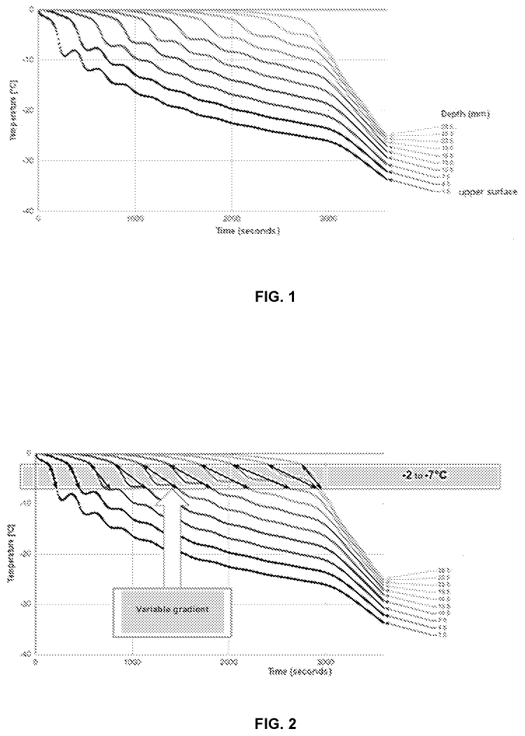

Thus, the appended FIG. 1 and FIG. 2 show the results of simulation of a deep freezing process according to the prior art (“standard”) in a deep freezing cabinet of this type, i.e. with a freezing temperature constant over a period of time, using a coefficient of thermal transfer constant over a period of time.

This simulation was carried out using the following parameters:
product: beef 5% MG (thermal properties close to those of the tylose gel);
initial temperature=0° C.;
thickness 30 mm, meat placed on a 30 mm layer of insulation in order to eliminate the exchanges via its lower face;
deep freezer=a Cryo-Cabinet (L'AIR LIQUIDE) with a constant temperature of −51° C. and constant ventilation regulated to 100% (full capacity).

Freezing to −28° C. on average was then obtained in 1 hour with a temperature of the freezer set to −51° C.

FIG. 1 and FIG. 2 represent different temperature curves of a product, on a time basis, with a curve for each depth in the interior of the product.

For each curve, an arrow is shown at the top of the curve, representing the speed of deep freezing, which is high at the start of the process (almost vertical), and lower at the end of the process (arrows tending to be almost level).

In addition, the arrows are close at the start and spaced at the end, which shows a freezing front with an advance which is rapid at the start and slower at the end.

This clearly shows the fact that, according to the prior art, the surface of the product is frozen far faster than the core according to the prior art.

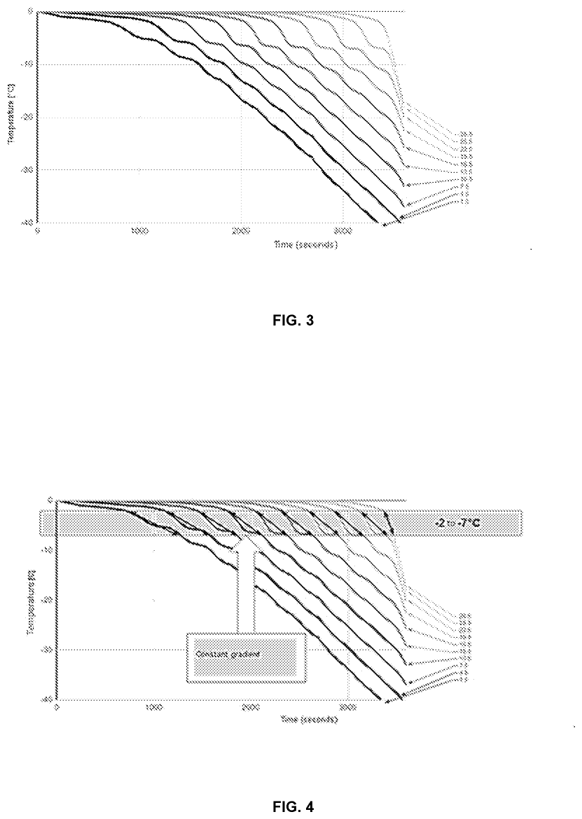

The appended FIG. 3 and FIG. 4 show the results of simulation of a deep freezing process according to the invention in a deep freezing cabinet of this type, implementing a constant speed of deep freezing.

This simulation was carried out using the following parameters:
product: beef 5% MG (thermal properties close to those of the tylose gel);
initial temperature=0° C.;
thickness 30 mm, meat placed on a 30 mm layer of insulation in order to eliminate the exchanges via its lower face;
deep freezer=a Cryo-Cabinet with a variable temperature equal to:

T=−(90×time in seconds)/3600.

The temperature thus varies linearly from 0 to −90° C. in 1 hour with constant ventilation regulated to 100% (full capacity).

Freezing to −28° C. on average is obtained in 1 hour with a set temperature of the deep freezer which varies from 0° C. to −90° C.

In this case also, FIG. 3 and FIG. 4 represent different temperature curves on a time basis, i.e. a curve for each depth in the interior of the product.

In this case also, for each curve an arrow is shown at the top of the curve, representing the speed of deep freezing, which in this case is substantially constant.

More specifically, it can be seen that in the area concerned, i.e. in the deep freezing area, where the water is transformed into ice, there are now gradients (deep freezing speed) which are in fact constant

Furthermore, the arrows are more or less equidistant, meaning that the freezing front advances at a constant speed. This is in fact what is found in tests with real product on the section of product.

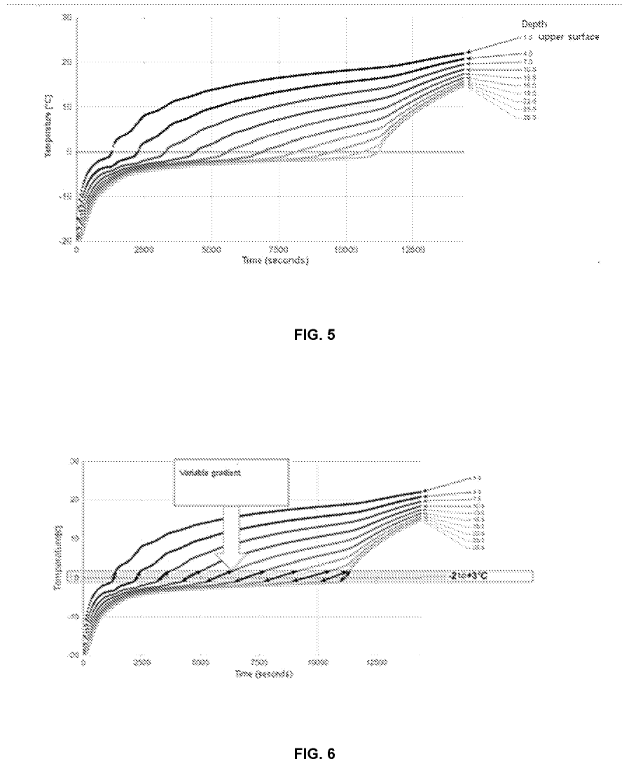

Reference can now be made to the appended FIG. 5 and FIG. 6, which show the results of simulation of a defrosting process according to the prior art (“standard”) in equipment of the cabinet type.

This simulation was carried out using the following parameters:
product: beef 5% MG (thermal properties close to those of the tylose gel);
initial temperature=−20° C.;
thickness 30 mm, meat placed on a 30 mm layer of insulation in order to eliminate the exchanges via its lower face;
equipment=heating cabinet with a fixed temperature equal to +31° C. and constant ventilation regulated to 100% (full capacity).

Complete defrosting is obtained at +17° C. on average, and in 4 hours with a set temperature of the deep freezer fixed at 31° C.

These figures represent different temperature curves of the product, on a time basis, with a defrosting curve for each depth in the interior of the product.

Also, for each curve, an arrow is shown at the bottom of the curve, representing the defrosting speed (temperature increase), which is at a high speed at the start of the process (almost vertical), and lower at the end of the process (arrows tending to be almost level).

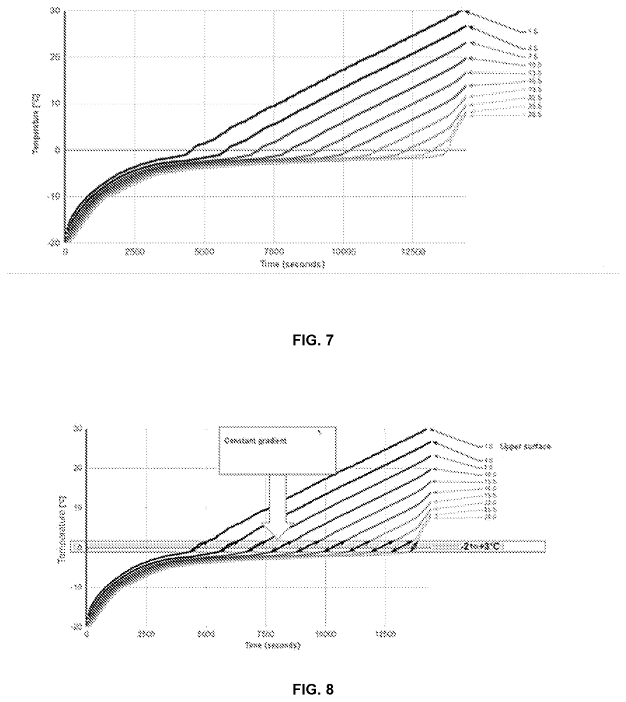

On the other hand, the appended FIG. 7 and FIG. 8 show the results of simulation of a defrosting process according to the invention in a cabinet of this type, implementing a constant defrosting speed, and it can clearly be seen that the gradients and defrosting speeds are constant throughout the curves and throughout the depths.

This simulation was carried out using the following parameters:
product: beef 5% MG (thermal properties close to those of the tylose gel);
initial temperature=−20° C.,
thickness 30 mm, meat placed on a 30 mm layer of insulation in order to eliminate the exchanges via its lower face;
equipment=heating cabinet with a variable temperature equal to:

T=+(50×time in seconds)/3600/4
(the temperature varies linearly from 0 to +50° C. in 4 hours) with constant ventilation regulated to 100% (full capacity).

Complete defrosting is obtained at +17° C. on average, and in four hours with a set temperature of the deep freezer which varies from 0° C. to +50° C.

To summarise, it can clearly be seen that both in terms of freezing and defrosting, the invention provides conditions which make it possible to improve the quality of the frozen and defrosted products, in particular fragile products.

The present invention has thus been described above, and proposes implementation of one or each of the following embodiments for the deep freezing of products:
a first embodiment where the temperature which exists in the installation is not constant, and is relatively high (i.e. not too cold) at the start of the process, and colder at the end of the process in order to stimulate the deep freezing, which slows down.
   It can be considered that, according to the invention, the initial temperature at the start of the process is preferably between +10 and −10° C., whereas the final temperature will preferably be between −20 and −150° C.
   Likewise the speed of descent into cold will preferably be between 1 and 0.001° C./second.
a second embodiment where the temperature which exists in the enclosure has a fixed and given set point, whereas the coefficient of thermal transfer is regulated so as to be low at the start of the process and higher at the end of the process (for this purpose, the speed of ventilation is slow at the start of the deep freezing cycle, and hire at the end of deep freezing).
In this case, the deep freezing process will preferably be started with a convection speed (speed of rotation of the fans for example) of between 1 and 10% of the full speed, and the process will preferably be finished at a speed of between 50 and 100% of the full speed.
a third mode where the two preceding modes are associated (variation of the temperature and variation of the coefficient of thermal transfer).

The present invention also concerns a process for defrosting of products, in particular foodstuffs, pharmaceutical or also biological products, wherein the products are subjected in an enclosure of the deep freezing cabinet type to a profile of raising of the temperature, characterised in that the products are subjected to a constant defrosting speed throughout the process, by implementation of one or each of the following embodiments:
According to a first embodiment, the temperature which exists in the installation is not constant; at the start of the process it is preferably between +10° C. and −10° C., whereas the final temperature is preferably between +10 and +80° C., the temperature increase speed preferably being between 1° C./s and 0.001° C./second.
According to a second embodiment, the temperature which exists in the enclosure has a fixed and given set point, whereas the coefficient of thermal transfer is regulated so as to be low at the start of the process and higher at the end of the process. For this purpose the ventilation speed is slow at the start of the defrosting cycle and higher at the end of defrosting, because of the fact that the defrosting process preferably starts with a ventilation speed of between 1 and 10% of the full speed, and the defrosting process ends with a speed of between 50 and 100% of the full speed.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising,” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

1. A process for deep freezing of products, in particular foodstuffs, pharmaceutical or biological products, wherein the products are subjected in an enclosure of a deep freezing cabinet type to transfer of cold, wherein the products are subjected to a constant deep freezing speed throughout the process, the process comprising one or each of the following steps:
performing a first step, wherein a coefficient of thermal transfer is constant and a temperature existing in the enclosure is not constant, which is colder at the end of the process than at the start of the process in order to stimulate a deep freezing; and
performing a second step, wherein the temperature which exists in the enclosure during the process is constant over a period of time, as set at a given set point, whereas the coefficient of thermal transfer is regulated so as to be higher at the end of the process than at the start of the process.

2. The process for deep freezing of products of claim 1, wherein an initial temperature at the start of the process is between +10° C. and −10° C.

3. The process for deep freezing of products of claim 1, wherein a final temperature at the end of the process is between −20 and −150° C.,

4. The process for deep freezing of products of claim 1, wherein the constant deep freezing speed is between 1° C. and 0.001° C./second during the deep freezing.

5. The process for deep freezing of products of claim 1, wherein a speed of rotation of fan(s) presented in the enclosure is between 1 and 10% of its/their full speed at the start of the process.

6. The process for deep freezing of products of claim 1, wherein a speed of rotation of fan(s) presented in the enclosure is between 50 and 100% of its/their full speed at the end of the process.

7. A process for defrosting of products, in particular foodstuffs, pharmaceutical or biological products, wherein the products are subjected in an enclosure of the deep freezing cabinet type to a temperature increase profile, wherein the products are subjected to a constant defrosting speed throughout the process, the process comprising one or each of the following steps:
performing a first step, wherein a temperature which exists in the enclosure is not constant, wherein at the start of the process an initial temperature is lower than an final temperature during the defrosting;
performing a second step, wherein the temperature which exists in the enclosure has a fixed and given set point, whereas a coefficient of thermal transfer is regulated so as to be higher at the end of the process than at the start of the process, a speed of rotation of fan(s) present in the enclosure is higher at the end of defrosting cycle than at the start of the defrosting cycle.

8. The process for defrosting of products of claim 7, wherein at the start of the process an initial temperature is between +10° C. and −10° C.

9. The process for defrosting of products of claim 7, whereas at the end of the process an final temperature is between +10 and +80° C.

10. The process for defrosting of products of claim 7, wherein during the defrosting a temperature increase speed is between 1° C./s and 0.001° C./second.

11. The process for defrosting of products of claim 7, wherein a speed of rotation of fan(s) present in the enclosure at the start of the process is between 1 and 10% of the full speed.

12. The process for defrosting of products of claim 7, wherein a speed of rotation of fan(s) present in the enclosure at the end of the process is between 50 and 100% of the full speed.
